(19) United States
(12) Patent Application Publication
(10) Pub. No.: US 2011/0232469 A1
(43) Pub. Date: Sep. 29, 2011

(54) SAFETY DEVICE WITH CABLE OR ROPE CUTTING IN AN EXPLOSIVE ENVIRONMENT

(75) Inventor: Mathieu Deleignies, Wasquehai (FR)

(73) Assignee: NEREUS Technologies, Wasquehai (FR)

(21) Appl. No.: 13/125,646

(22) PCT Filed: Oct. 23, 2009
(86) PCT No.: PCT/FR2009/001239

§ 371 Date: Jun. 7, 2011

(30) Foreign Application Priority Data
Oct. 23, 2008 (FR) 0805871
Oct. 22, 2009 (FR) 0957416

(51) Int. Cl. B26D 1/00; B26D 7/22; B23D 15/14; B23D 29/00

(52) U.S. Cl. 89/1.14; 83/745; 83/372

(57) ABSTRACT

The present invention relates to a device for automatically and autonomously releasing a mechanical cable or rope connection between two elements, in a zone having explosive atmospheric conditions, comprising: a mechanical assembly in the form of an enclosure which can be traversed by a cable or rope and which contains at least one sectioner comprising a chisel associated with an anvil and means for moving the chisel with respect to the anvil in order to cut the cable or rope, means for positioning the cable or rope making it possible to pass the cable or rope between the anvil and the chisel, and means for measuring the tension of the cable or rope; the control means making it possible to automatically trigger the sectioner. The chisel and preferably the anvil are made of an anti-spark material, particularly of a beryllium-copper (Be—Cu) alloy.

### OBJECT OF THE INVENTION

The present invention relates to a safety device in applications requiring means for releasing the mechanical cable or rope connection of an assembly of two elements, in particular in an explosive environment.

In one particular application, the invention can be used to secure uses of the marine loading/unloading arms of vessels transporting liquid or gas fuel, such as methane or oil tankers, more particularly in offshore applications.

The invention is not, however, limited to only this application, and can for example also be used in other applications, to release the mechanical cable or rope connection between two elements in an explosive atmosphere, and for example the mooring or anchoring connection of a floating element, such as in particular an offshore platform, a methane tanker, or an oil tanker.

### BACKGROUND OF THE INVENTION

In the specific field of loading and unloading methane and/or oil, it is known to use loading and unloading installations that are installed on offshore platforms or piers several miles from the coast. This makes it possible to avoid, in case of problems during the transfer, damage or pollution of the surrounding environment, a town next to the coast, for example.

In this context, document FR-A-2 854 156 describes a loading/unloading assembly for fluid products, including a balanced loading/unloading arm installed at a first location and having a channeling compass mounted by one of its ends on a base and provided at its other end with a connection system adapted to connect the channeling compass to a coupling means installed at the second location. This assembly also includes a cable connected on one hand to means secured to the base and adapted to subject the cable to a constant tension and able to be connected, on the other hand, to the second location (to the manifold of the vessel). It also includes guide means able to cooperate with the cable so as to guide the connecting system along a trajectory materialized by said cable until it brings the connecting system into a connection position via coupling.

Not being protected by embankments, these installations therefore have an articulated compass arm equipped with a guide cable and synchronization system, hereinafter referred to as cable guide means, to bring the connection valve situated on the platform to the flanges of the manifold of the vessel or boat, without being bothered by the movements of the vessel due to the swell.

FIG. 1, adapted from document FR-A-2 854 156, shows an example of a guide means of the cable equipping a liquefied natural gas loading arm 1. It is made up of:

a constant-tension winch 2;

an approach winch 3;

a cable 4;

a return pulley 5;

an end trunnion and the motorization of the rotation 6;

a female cone for the alignment 7;

a spool 8 with a male receiving cone and fastening means of the cable.

The aim of the cable guide means is to progressively apply the movements of the boat related to the presence of waves or swell to the loading arm through the connection time on the manifold of the boat. The cable 4 is kept under constant tension so as to guide the end of the arm towards the manifold of the boat 9. During this phase, the arm 3. is “freewheeling” and is guided only by the cable 4.

The cable 4 is kept under tension between the manifold of the boat 9 and the base 10 of each arm. This tension is applied using the winch at constant tension 2 placed at the foot of the base 10. This winch uses a hydraulic motor that is powered by a constant hydraulic pressure. If he distance between the boat and the pier increases, the winch will let the cable unwind while keeping the cable taut. If the distance between the boat and the pier decreases, the winch will wind the cable while always keeping the tension in the cable constant.

To bring the arm 1 closer to the manifold of the boat 9, the end of the arm placed “freewheeling” is guided by the cable 4 and a specific winch called “approach winch” 3 placed at the end of the arm 1 pulls the latter in one direction or the other using the friction from the cable.

The cable 4 passes through a female cone 7 also situated at the end of the arm 1. The cable 4 is then fastened to the male cone 8 situated on the manifold of the boat 9.

At the end of the approach phase, the cones 7, 8 engage one inside the other, which makes it possible to ensure good alignment. Once the arm is connected, the constant tension is released. The other arms are connected using the same procedure.

To disconnect, the same principle is used. The only difference is that the approach winch 3 will be activated in the other direction.

The maximum axial force allowed at the boat's manifolds is several tons. There is a hydraulic valve releasing pressure in case of hydraulic problems on the constant tension winch, situated at the foot of the arm.

In the event of an emergency disconnection, the guide cable unwinds itself from the drum of the winch of the considered arm and falls in the water. Nevertheless, in the event of mechanical locking of the constant tension winch, the cable remains attached at both ends and the cable can no longer unwind. If the boat continues to move following the waves or moves away due to a substantial drift, the force applied on the boat's manifold is absolutely no longer controlled and can greatly exceed the admissible threshold for these manifolds. If this type of mechanical locking occurs, there is a risk of damaging the boat's manifolds before the cable breaks.

To solve this problem, an automatic cable sectioner should be used, which is able to section the guide cable regardless of the operating phase of the loading arm (connection or disconnection of the arm on the boat's manifolds, loading or unloading).

Moreover, the loading/unloading arms of the aforementioned type evolve in atmospheres classified as “Explosive Atmospheres.” They must therefore be in compliance with European directive “94-9-CE ATEX.” Thus, in the case of implementation of an automatic sectioner for loading/unloading arm cable of the aforementioned type, this directive is also applicable to such a sectioner.

There is therefore a need, not met to date, for a technical solution making it possible to automatically section, reliably and precisely, and without an explosion risk, such a loading/unloading arm cable of a methane or oil tanker, in the event the winch of the arm is locked.

There are also a number of other applications in explosive atmospheres in which there is a need, not met to date, for a technical solution making it possible to quickly and reliably automatically section, without explosion risk, a mechanical cable or rope connection, in the event of abnormal and excessive tension exerted on the mechanical connection.

These may for example be all applications using an element that is moored or anchored, such as an oil or gas platform, an oil tanker, a methane tanker, etc., and for which there is also a need to have a technical solution making it possible to quickly and reliably automatically section, without a risk of explosion, the mechanical mooring or anchoring connection, in the event of abnormal and excessive tension exerted on said mechanical connection. This type of application is described for example in the following patent applications: EP-A-1 462 358, EP-A-0 729 882, EP-A-1 705 112, WO-A-2005/045302, WO-A-99/57008, WO-A-98/15449.

It has also already been proposed in the prior art to use pyrotechnical sectioners to section cables.

For example, document FR-A-2 897 548 discloses a security system for a boat including a cable connected to the boat by a first end and being submerged by its second end to which an object is attached of a nature to drag while submerged, e.g. a fishing net. This system comprises means for detecting the position of the boat, means for detecting the tension of the cable, at least one alarm system controlled by electronic means, and a cable sectioner that can be controlled remotely and having means for positioning the cable capable of scrolling. In this way, it is possible to section a cable as a function of abnormal trim conditions, i.e. the position of the boat and tension of the cable, i.e. under abnormal buoyancy conditions of the boat due to very large resistance due to the object fixed to the end of the cable, such as a fishing net.

Cable sectioners are also known. Document U.S. Pat. No. 6,878,024 B1 describes a hydrostatic release system intended to cut a cable securing a floating object to a marine vehicle, when the latter is submerged at a predetermined depth. The lighting of a pyrotechnical sectioner is triggered when said depth is detected. Document WO 2007/096335 A1 discloses a pyrotechnical cable sectioner, using a hollow charge, having a V-shaped transverse structure section and a partially annular shape, so as to partially surround the piece with a circular section to be sectioned and comprising means for starting the hollow charge and means for positioning the piece with a circular section to be sectioned relative to the hollow charge. Other pyrotechnical sectioners are described in documents U.S. Pat. No. 5,177,317 A, WO 94/25212 A1, and U.S. Pat. No. 6,349,474 B1.

All of the aforementioned pyrotechnical sectioners of the prior art use an explosive charge to trigger pyrotechnical shearing, and are not suitable for use, without an explosion risk, in a zone having explosive atmosphere conditions. It was therefore inconceivable until now to try to use a pyrotechnical sectioner to automatically section a mechanical connection, in an explosive atmosphere, such as in particular the cable of a loading/unloading arm of a methane and/or oil tanker, or the mooring or anchoring connection of an oil or gas platform, an oil tanker, or a methane tanker.

### AIMS OF THE INVENTION

The present invention aims primarily to propose a new technical solution that can be used in an explosive atmosphere, and which makes it possible to automatically and reliably, without explosion risk, release a mechanical cable or rope connection between two elements, in the event in particular of excessive tension exerted on the mechanical connection.

Furthermore, but optionally, the technical solution according to the invention must preferably meet the requirements of the European “94-9-CE ATEX” directive.

### BRIEF DESCRIPTION OF THE INVENTION

According to a first aspect, the invention relates to a device for automatically releasing a mechanical cable or rope connection between two elements, in a zone having explosive atmosphere conditions; said device comprises:

a mechanical assembly in the form of an enclosure that is able to be traversed by a cable or rope and which contains at least one sectioner comprising a chisel associated with an anvil and means for moving the chisel relative to the anvil to cut the cable or rope, means for positioning the cable or rope making it possible to pass the cable or rope between the anvil and the chisel, and means for measuring the tension of the cable or rope,
control means (12) making it possible to automatically control the triggering of the sectioner,
the chisel of the sectioner being made from an anti-spark material.

According to a second aspect, the invention relates to a device for automatically releasing a mechanical cable or rope connection between two elements, in a zone having explosive atmosphere conditions; said device comprises:

a mechanical assembly in the form of an enclosure that can be traversed by a cable or rope and that contains at least one sectioner for cutting the cable or rope, means for positioning the cable or rope, and means for measuring the tension of the cable or rope,
control means making it possible to automatically control the triggering of the sectioner,
in which device the enclosure is subdivided into at least two chambers: a main chamber that can be traversed by the cable or rope and that contains at least said sectioner, said means for positioning the cable or rope, and said means for measuring the tension of the cable or rope, and at least one adjacent side expansion chamber, the inner wall separating the main chamber from the side expansion chamber being provided with a plurality of orifices and serving as a flame arrester.

According to particular embodiments of the invention, the aforementioned device may also comprise a combination of one or more of the following features:
the anvil is made from an anti-spark material;
the device includes one or more fixed guides that make it possible to guide the cable or rope in the enclosure and that are made from an anti-spark material;
the anti-spark material is a copper-beryllium alloy (Cu—Be);
the anti-spark material is a metal chosen from amongst the following group: brass, bronze, copper-nickel alloy, copper-aluminum alloy, titanium;
the sectioner is a pyrotechnical sectioner;
the control means (12) make it possible to automatically trigger the sectioner, based on the measurement of the tension in the cable or rope, when a predetermined tension threshold is reached;
the enclosure includes an inlet opening and an outlet opening for the cable or rope, the two openings being equipped with rollers, preferably made from PTFE, configured to limit the intake of air or outside gas inside the enclosure;
the enclosure is subdivided into at least two chambers: a main chamber that can be traversed by the cable or rope and that contains at least said sectioner, said means for positioning the cable or rope, and said means (16) for measuring the tension of the cable or rope, and at least one adjacent side expansion chamber, the inner wall separating the main chamber from said side expansion chamber being provided with a plurality of openings and acting as a flame arrester;
the enclosure is subdivided into at least three chambers: the main chamber that can be traversed by the cable or rope and that contains at least said sectioner, said means for positioning the cable or rope, and said means for measuring the tension of the cable or rope (4), and two adjacent side expansion chambers on either side of the main chamber, each inner wall separating the central main chamber from each of the two side expansion chambers being provided with a plurality of openings and serving as a flame arrester;
said openings of each flame arrester inner wall of each side expansion chamber have a diameter smaller than 15 mm;
said openings are initially obstructed by plugs during the phase for measuring the cable tension before any triggering of the device.
each side expansion chamber includes an outer flame arrester wall provided with a plurality of openings that make it possible to put the side chamber in communication with the outside;
said openings of each outer flame arrester wall (P′) of each side expansion chamber have a diameter smaller than 15 mm;
the openings of each outer flame arrester wall (P′) of each side expansion chamber are initially obstructed by plugs during the phase for measuring the cable tension before any triggering of the device;
the sectioner comprises a chisel (25) associated with an anvil and means for moving the chisel relative to the anvil to cut the cable or rope, the chisel being made from an anti-spark material;
the means for measuring the tension of the cable or rope are configured so that the cable or rope exerts a radial force on said measuring means proportional to the tension of the cable or rope;
the means for measuring the tension of the cable comprise a central pulley as well as two pulleys surrounding the central pulley, which ensure a constant angle between the cable and the central pulley upstream and downstream of said central pulley, and a dynamometric system located inside the axis of the central pulley;
said dynamometric system comprises two strain gauges;
the control means are situated outside the enclosure, are connected to said mechanical assembly, preferably by a wire connection, and can be positioned outside the zone having explosive atmosphere conditions.

The invention also relates to a security system for loading/unloading arms of a vessel transporting liquid or gaseous fuel, said arm being equipped with a mechanical cable connection and guide system of said arm, more simply referred to as cable guiding means, for its connection/disconnection relative to a manifold of said vessel, said system comprising a device as previously cited making it possible to automatically release the aforementioned mechanical cable connection.

According to particular embodiments of the invention, the aforementioned security system also comprises a combination of one or more of the following features:
the cable guiding means comprises a constant tension winch situated at one end where the cable is secured to the arm;
said mechanical assembly of the device to automatically release the aforementioned mechanical cable connection is secured on a base of the arm or on the constant tension winch;
said mechanical assembly is at the same electric potential as the winch or the vessel.

The invention also relates to:
the use of the previously cited device to automatically section a mechanical cable or rope connection between two elements, in a zone having explosive atmosphere conditions;
the use of the previously cited device to automatically section the cable from a loading/unloading arm of a vessel;
the use of the previously cited device to automatically section a mooring or anchoring connection from a floating element, under explosive atmosphere conditions;
the use of the previously cited device to automatically section a mooring or anchoring connection from a floating element, such as an oil or gas platform, an oil tanker, or a methane tanker.

### BRIEF DESCRIPTION OF THE FIGURES

FIG. 1, already mentioned, diagrammatically illustrates an example of a loading arm for liquefied natural gas, installed on a pier to load and unload a methane tanker and equipped with a cable guide means.

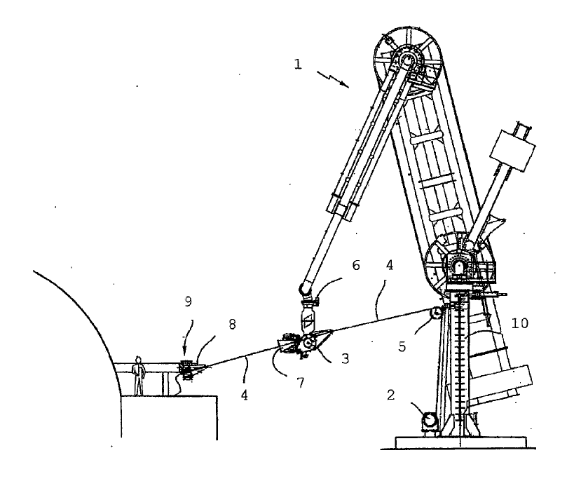

FIG. 2 shows the same loading arm equipped with the cable guide means and provided with a security device according to the present invention, made up of a mechanical measuring assembly and for residentially positioning the pyrotechnical sectioner, positioned on the cable along the loading arm of FIG. 1, and an acquisition and control station situated outside the explosion hazard zone.

FIGS. 3A, 3B show detailed views of the mechanical part of the security device according to the present invention.

FIG. 3C is a longitudinal cross-sectional view of the enclosure of another alternative embodiment of the security device according to the present invention.

FIGS. 4A and 4B show an embodiment of the pyrotechnical sectioner used according to the invention, before and after lighting said sectioner, respectively.

### DETAILED DESCRIPTION OF THE INVENTION

The present invention proposes a piece of security equipment 11, 12, 13 comprising an automatic pyrotechnical sectioner that can be used in an explosive atmosphere and that is equipped with an element for measuring the tension of the cable and means for cutting the cable if the measured tension of the cable exceeds a predetermined critical threshold.

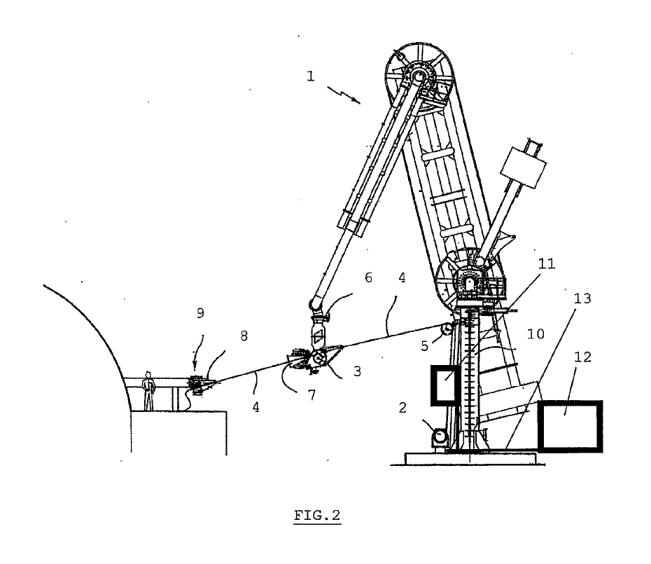

In the particular and non-limiting application of the invention, illustrated in FIG. 2, this security equipment is mounted on the cable of a loading arm of a vessel of the oil and/or methane tanker type, and makes it possible to automatically cut the cable from said arm if the measured tension of the cable exceeds a predetermined critical threshold that can lead to damage of the loading arm or of the vessel transporting the fuel.

In this device, the measurement of the cable tension is done continuously. If the cable tension therefore exceeds a predefined value, the device sends the order to cut the cable. This cutting is advantageously done using either a pyrotechnical cable sectioner, or a pyrotechnical cable cutter, or using any hydraulic, electric, or pneumatic sectioner.

The security equipment according to the invention not only comprises a mechanical assembly 11 for measuring and positioning the pyrotechnical sectioner along each loading arm, but also an acquisition and control station 12 advantageously and preferably situated outside the potentially explosive zone (see FIG. 2). The connection between the mechanical assembly 11 and the control station 12 is preferably a wire connection 13, but could also be a wireless connection.

Preferably, the mechanical assembly will 11 advantageously be at the same electric potential as the constant tension winch 2.

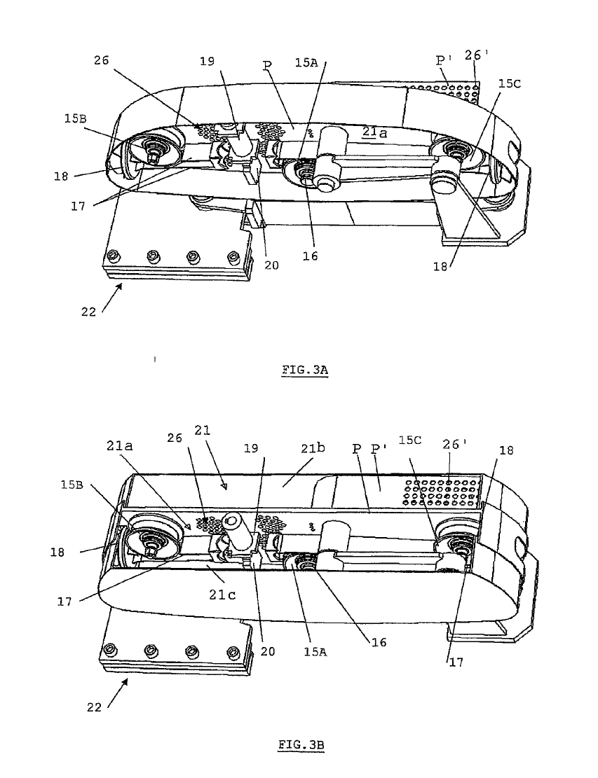

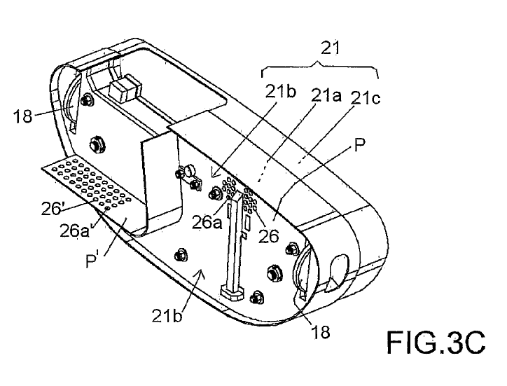

FIG. 3A shows a longitudinal cross-section of the mechanical device according to the invention installed residentially on the cable 4. This device comprises an enclosure 21 subdivided into a main chamber 21a and two gas expansion side chambers 21b, 21c. The main chamber 21a respectively contains pulleys 15A, 15B, 15C for guiding and positioning the cable, a dynamometric axis 16 in the form of two strain gauges situated inside the axis of the pulley, a fixed guide 17 for guiding the cable, rollers made from PTFE 18, a pyrotechnical sectioner 19 with an anvil 20. FIG. 3B is a transverse cross-sectional view of the same device. It is shown with its attachment means 22 for attachment to the loading arm.

### Principle of Measuring the Cable Tension

In the device shown in FIGS. 3A and 3B, the cable 4 exerts a force on the central pulley 15A that is proportional to the tension of the cable. This tension also depending on the variation of the angle of the cable upstream and downstream of the central pulley, the two end pulleys 15B, 15C ensure a constant angle.

### Controlling the Sectioner

The signals delivered by the strain gauges of the dynamometric axis 16 are characteristic of the mechanical tension in the cable 4 and are processed by the offboard control station 12. This control station 12 includes electronic control means making it possible to automatically compare the measured tension with a predetermined threshold, and control means connected to the sectioner 19 and making it possible to automatically control the triggering of the sectioner 19 to cut the cable 4 if the cable tension detected by the dynamometric axis 16 exceeds the predefined threshold.

### Principle of Pyrotechnical Shearing

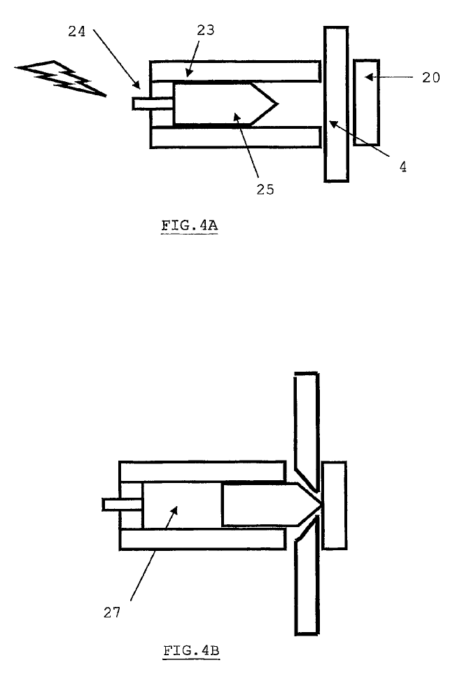

The pyrotechnical sectioner 19 is preferably pyrotechnical shears commonly used to cut cables in the industry. Pyrotechnical shears are preferably used that will not allow the hot gas to escape towards the outside (see FIGS. 4A and 4B). The pyrotechnical shears will for example be formed by a hollow cylindrical body 23 and an anvil 20. The first end of the body 23 contains the powder cartridge 24 and the other end is opposite the cable 4 to be sectioned. The hollow cylindrical body contains the chisel 25, which will section the cable 4 when it is projected thereon by the deflagration. After the deflagration of the powder cartridge 24, the hot gas 27 is confined in the body 23 of the shears, at the rear of the chisel 25 (FIG. 4B).

Taking the Atmosphere (ATEX) into Account

Several barriers have been provided in the device according to the invention to prevent the device from communicating a deflagration to the outside environment in the event of pyrotechnical cutting of the cable (see FIGS. 3A, 3B, 3C):
in order to prevent the explosive gaseous mixture (air/methane or other) from being introduced inside the device, the openings to the outside are reduced using PTFE rollers 18. In this way, only a minimal amount of gaseous mixture can be introduced inside the device. The size of the passage openings for the cable is advantageously adapted to the type of gaseous mixture;
in order to prevent the explosive gaseous mixture from igniting if it were nevertheless to be found in a non-negligible concentration inside the device, the chisel 25, and preferably the anvil 20 of the pyrotechnical sectioner, are chosen in an anti-spark material; preferably, this anti-spark material is a special copper alloy (CuBe2). This specific alloy makes it possible to prevent any risk of sparks inside the device when the chisel 25 impacts a metal element, and in particular the cable and the anvil 20. This therefore prevents the gas that may be located therein from igniting;
lastly, to prevent the transmission to the outside environment of the deflagration generated if gas present inside were to ignite, it is provided that the small exchange surface with the outside prevents the spread of the flame. To that end, used as anti-flame barriers (cf. Davy miner's lamp, 1817) are attachments with holes 26, 26′ such that 2R/∂L<30, where D=2R is the diameter of the orifice and ∂L is the combustion length of the mixture (∂L=0.5 mm for the methane/air mixture, 2R=D<15 mm). These holes 26, 26′ are preferably hermetically obstructed by plugs in order to prevent fresh explosive gas mixture (air/methane) from penetrating therein during the cable tension measuring phase before any triggering of the device.

It will be noted that, according to the embodiments shown in FIGS. 3A, 3B and 3C, the main central chamber 21a that is in limited communication with the outside through the inlet and outlet openings of the cable, is positioned between two gas expansion side chambers 21b, 21c that are adjacent to the main chamber 21a and situated on either side of the main chamber 21a. These will serve for the expansion of the burned gases, in order to reduce their temperature below the auto-ignition temperature of the explosive gas mixture, before they are discharged to the outside. They are in communication with the central chamber 21a through flame arrester plates P with holes 26 whereof the function has been previously described. In FIGS. 3A, 3B, only the inner flame arrester wall P separating the main chamber 21a from the side chamber 21b is visible; for clarity of the drawings, the flame arrester wall P separating the main chamber 21a from the other side chamber 21c has not been shown. Preferably, but not necessarily, the openings 26 are preferably hermetically obstructed by removable plugs 26a (visible in the alternative of FIG. 3C), in order to prevent the fresh explosive gas mixture (e.g. air/methane) from penetrating the main chamber 21a by passing through the openings 26 during the cable tension measuring phase before any triggering of the device.

The device therefore behaves like an anti-deflagration enclosure and resists the deflagration of the explosive gaseous mixture that may be located therein.

In the particular alternative embodiments shown in FIGS. 3A, 3B, 3C, each side expansion chamber (21b, 21c) also includes an outer wall P′ pierced by a plurality of openings 26′ that make it possible to put the side chamber in communication with the outside, and to discharge, if applicable, an excessive overpressure of gas inside the side chamber. As previously explained, these openings 26′ are dimensioned so that the outer wall P′ also acts as a flame arrester. In another alternative, these openings 26′ may not be provided, the outer wall P′ in that case being a sealing wall.

In the alternative of FIG. 3C, and optionally, the openings 26′ of each outer wall P′ are advantageously hermetically obstructed by removable plugs 26′a, in order to prevent fresh explosive gas mixture (e.g. air/methane) from penetrating from the outside into the corresponding side chamber 21b or 21c by passing through the openings 26′ during the cable tension measuring phase before any triggering of the device.

Significant Difference from the Application for Fishing Boats (Application FR-A-0 650 587)

The presence of the explosive atmosphere is the first of the notable differences, resulting in the placement of the various aforementioned anti-deflagration barriers.

The measurement of the cable tension is done using three pulleys and not two, which allows the central pulley to receive a radial force proportional to the tension of the cable.

The tension sensor is an assembly of two strain gauges placed inside the axis of the central pulley.

The pyrotechnical sectioner is different due to the nature of the environment.

The alert modes are different, since the information is not visible by the people in the control cabin, the cutting being done automatically beyond a certain tension threshold.

The invention is not limited to the specific embodiments of FIGS. 3A, 3B, 3C or the specific application of FIG. 2 (loading/unloading arm of a vessel of the methane or oil tanker type).

In another alternative embodiment, it is possible to provide a single side expansion chamber 21b adjacent to the main chamber 21a, instead of two side expansion chambers 21b, 21c.

The sectioner 19 is not necessarily a pyrotechnical sectioner whereof the means for moving the chisel 25 relative to the anvil 20 would be made up of propulsion means of the powder cartridge type 24. In another alternative embodiment, to move the anvil 25, it is also possible to use other types of actuators, in particular with electric, hydraulic or pneumatic energy, making it possible to move or propel the chisel 25 into contact with the cable 4 with a sufficient speed to section the cable 4.

When the chisel 25 and, if applicable, the anvil 20 are made from an anti-spark material, the latter is not necessarily a copper-beryllium alloy (Cu—Be), but can also be one of the following metals: brass, bronze, copper-nickel alloy, copper-aluminum alloy, titanium.

The main chamber 21a of the device in which the cable 4 passes can include one or more fixed elements for guiding the cable 4, such as the aforementioned guide 17, against which the cable rubs. When the cable 4 is made from metal, in order to prevent sparks from forming during sliding of the metal cable 4 in contact with these guide elements, such as the aforementioned guide 17, it is also preferable for these fixed guide elements also to be made from an anti-spark material.

The control station 12 is not necessarily situated outside the enclosure 21 of the device. In one alternative, the control station 12 can be made in the form of an electronic circuit placed inside the enclosure 12 of the cutting device, and in particular inside the main chamber 21a. In this case one preferably ensures that the electrical connections of this circuit are protected from the gas contained in the enclosure, for example by encapsulating these electrical connections in a resin.

The device according to the invention can more generally be used to automatically section a mechanical cable or rope connection between two elements, in a zone having explosive atmosphere conditions.

More particularly, the inventive device can be used to automatically section a mooring or anchoring connection of a floating element, under explosive atmosphere conditions, such as in particular a mooring or anchoring connection of a floating element, of the oil or gas platform, oil tanker, or methane tanker type.

1. A device for automatically releasing a mechanical cable or rope connection between two elements, in a zone having explosive atmosphere conditions, said device comprising:
a mechanical assembly in the form of an enclosure that is able to be traversed by a cable or rope and which contains at least one sectioner comprising a chisel associated with an anvil and means for moving the chisel relative to the anvil to cut the cable or rope, means for positioning the cable or rope making it possible to pass the cable or rope between the anvil and the chisel, and means for measuring the tension of the cable or rope,
control means making it possible to automatically control the triggering of the sectioner,
the chisel of the sectioner being made from an anti-spark material.

2. The device according to claim 1, wherein the anvil is made from an anti-spark material.

3. The device according to claim 1, further including one or more fixed guides that make it possible to guide the cable or rope in the enclosure and that are made from an anti-spark material.

4. The device according to claim 1, wherein the anti-spark material is a copper-beryllium alloy (Cu—Be).

5. The device according to claim 1, wherein the anti-spark material is a metal chosen from amongst the following group: brass, bronze, copper-nickel alloy, copper-aluminum alloy, titanium.

6. The device according to claim 1, wherein the sectioner is a pyrotechnical sectioner.

7. The device according to claim 1, wherein the control means makes it possible to automatically trigger the sectioner, based on the measurement of the tension in the cable or rope, when a predetermined tension threshold is reached.

8. The device according to claim 1, wherein the enclosure includes an inlet opening and an outlet opening for the cable or rope, the two openings being equipped with rollers, preferably made from PTFE, configured to limit the intake of air or outside gas inside the enclosure.

9. The device according to claim 1, wherein the enclosure is subdivided into at least two chambers: a main chamber that can be traversed by the cable or rope and that contains at least said sectioner, said means for positioning the cable or rope, and said means for measuring the tension of the cable or rope, and at least one adjacent side expansion chamber, the inner wall separating the main chamber from said side expansion chamber being provided with a plurality of openings and acting as a flame arrester.

10. The device according to claim 9, wherein the enclosure is subdivided into at least three chambers: the main chamber that can be traversed by the cable or rope and that contains at least said sectioner, said means for positioning the cable or rope, and said means for measuring the tension of the cable or rope, and two adjacent side expansion chambers on either side of the main chamber, each inner wall separating the central main chamber from each of the two side expansion chambers being provided with a plurality of openings and serving as a flame arrester.

11. The device according to claim 9, wherein said openings of each flame arrester inner wall of each side expansion chamber have a diameter smaller than 15 mm.

12. The device according to claim 9, wherein said openings are initially obstructed by plugs during the phase for measuring the cable tension before any triggering of the device.

13. The device according to claim 9, wherein each side expansion chamber includes an outer flame arrester wall provided with a plurality of openings that make it possible to put the side chamber in communication with the outside.

14. The device according to claim 13, wherein said openings of each outer flame arrester wall of each side expansion chamber have a diameter smaller than 15 mm.

15. The device according to claim 13, wherein said openings of each outer flame arrester wall of each side expansion chamber are initially obstructed by plugs during the phase for measuring the cable tension before any triggering of the device.

16. A device for automatically releasing a mechanical cable or rope connection between two elements, in a zone having explosive atmosphere conditions, said device comprising:
a mechanical assembly in the form of an enclosure that can be traversed by a cable or rope and that contains at least one sectioner for cutting the cable or rope, means for positioning the cable or rope, and means for measuring the tension of the cable or rope,
control means making it possible to automatically control the triggering of the sectioner,
in which device the enclosure is subdivided into at least two chambers: a main chamber that can be traversed by the cable or rope and that contains at least said sectioner, said means for positioning the cable or rope, and said means for measuring the tension of the cable or rope, and at least one adjacent side expansion chamber, the inner wall separating the main chamber from the side expansion chamber being provided with a plurality of orifices and serving as a flame arrester.

17. The device according to claim 16, wherein the enclosure is subdivided into three chambers: the main chamber, which can be passed through by the cable or rope and which contains at least said sectioner, said means for positioning the cable or rope, and said means for measuring the tension of the cable or rope, and two adjacent side expansion chambers on either side of the main chamber, each inner wall separating the central main chamber from each of the two side expansion chambers being provided with a plurality of openings and serving as a flame arrester.

18. The device according to claim 16, wherein said openings of each flame arrester inner wall of each side expansion chamber have a diameter smaller than 15 mm.

19. The device according to claim 16, wherein said openings are initially obstructed by plugs during the phase for measuring the cable tension before any triggering of the device.

20. The device according to claim 16, wherein each side expansion chamber includes an outer flame arrester wall provided with a plurality of openings that make it possible to put the side chamber in communication with the outside.

21. The device according to claim 20, wherein said openings of each outer flame arrester wall of each side expansion chamber have a diameter smaller than 15 mm.

22. The device according to claim 20, wherein said openings of each outer flame arrester wall of each side expansion chamber are initially obstructed by plugs during the phase for measuring the cable tension before any triggering of the device.

23. The device according to claim 16, wherein the sectioner comprises a chisel associated with an anvil and means for moving the chisel relative to the anvil to cut the cable or rope, the chisel being made from an anti-spark material.

24. The device according to claim 23, wherein the anvil is made from an anti-spark material.

25. The device according to claim 16, further including one or more fixed guides that make it possible to guide the cable or rope in the main chamber and that are made from an anti-spark material.

26. The device according to claim 23, wherein the anti-spark material is a copper-beryllium alloy (Cu—Be)

27. The device according to claim 23, wherein the anti-spark material is a metal chosen from amongst the following group: brass, bronze, copper-nickel alloy, copper-aluminum alloy, titanium.

28. The device according to claim 16, wherein the sectioner is a pyrotechnical sectioner.

29. The device according to claim 16, wherein the control means make it possible to automatically trigger the sectioner, based on the measurement of the tension in the cable or rope, when a predetermined tension threshold is reached.

30. The device according to claim 16, wherein the enclosure includes an inlet opening and an outlet opening for the cable or rope, the two openings being equipped with rollers, preferably made from PTFE, configured to limit the intake of air or outside gas inside the enclosure.

31. The device according to claim 1, wherein the means for measuring the tension of the cable or rope are configured so that the cable or rope exerts a radial force on said measuring means proportional to the tension of the cable or rope.

32. The device according to claim 30, wherein the means for measuring the tension of the cable comprise a central pulley as well as two pulleys surrounding the central pulley, which ensure a constant angle between the cable and the central pulley upstream and downstream of said central pulley, and a dynamometric system located inside the axis of the central pulley.

33. The device according to claim 31, wherein the dynamometric system comprises two strain gauges.

34. The device according to claim 1, wherein the control means are situated outside the enclosure, are connected to said mechanical assembly, preferably by a wire connection, and can be positioned outside the zone having explosive atmosphere conditions.

35. A security system for loading/unloading arms of a vessel transporting liquid or gaseous fuel, said arm being equipped with a mechanical cable connection and guide system of said arm, more simply referred to as cable guiding means, for its connection/disconnection relative to a manifold of said vessel, said system comprising a device as previously cited, according to claim 1.

36. The security system according to claim 35, wherein the cable guiding means comprises a constant tension winch situated at one end where the cable is secured to the arm.

37. The security system according to claim 35, wherein said mechanical assembly of the device to automatically release the aforementioned mechanical cable connection is secured on a base of the arm or on the constant tension winch.

38. A use of the device set out in claim 1 chosen from amongst the following group:
to automatically section a mechanical cable or rope connection between two elements, in a zone having explosive atmosphere conditions,
to automatically section the cable from a loading/unloading arm or vessel,
to automatically section a mooring or anchoring connection from a floating element, under explosive atmosphere conditions,
to automatically section a mooring or anchoring connection from a floating element, such as an oil or gas platform, an oil tanker, or a methane tanker.

39. (canceled)

40. (canceled)

41. (canceled)

42. The device according to claim 16, wherein the means for measuring the tension of the cable or rope are configured so that the cable or rope exerts a radial force on said measuring means proportional to the tension of the cable or rope.

43. A security system for loading/unloading arms of a vessel transporting liquid or gaseous fuel, said arm being equipped with a mechanical cable connection and guide system of said arm, more simply referred to as cable guiding means, for its connection/disconnection relative to a manifold of said vessel, said system comprising a device as previously cited, according to claim 16.

44. A use of the device set out in claim 16 chosen from amongst the following group:
to automatically section a mechanical cable or rope connection between two elements, in a zone having explosive atmosphere conditions,
to automatically section the cable from a loading/unloading arm or vessel,
to automatically section a mooring or anchoring connection from a floating element, under explosive atmosphere conditions,
to automatically section a mooring or anchoring connection from a floating element, such as an oil or gas platform, an oil tanker, or a methane tanker.
